(19) United States
(12) Patent Application Publication
(10) Pub. No.: US 2012/0331434 A1
(43) Pub. Date: Dec. 27, 2012

(54) COMPUTING DEVICE AND METHOD FOR CHECKING SIGNAL TRANSMISSION LINES

(75) Inventors: YA-LING HUANG, Shenzhen City (CN); CHIA-NAN PAI, Tu-Cheng (TW); SHOU-KUO HSU, Tu-Cheng (TW)

(73) Assignees: HON HAI PRECISION INDUSTRY CO., LTD., Tu-Cheng (TW); HONG FU JIN PRECISION INDUSTRY (ShenZhen) CO., LTD., Shenzhen City (CN)

(21) Appl. No.: 13/483,059

(22) Filed: May 30, 2012

(30) Foreign Application Priority Data
Jun. 24, 2011 (CN) 201110173963.8

(51) Int. Cl. G06F 17/50

(52) U.S. Cl. 716/111

(57) ABSTRACT

A computing device and a method reads design standards of signal transmission lines in a printed circuit board (PCB) layout file, and determines a minimum reference length of line segments of the signal transmission lines from the design standards. The device and method then selects a signal transmission line from a circuit board, and computes an actual length of each line segment of the selected signal transmission line. If each actual length is more than or equal to the minimum reference length, the device and method determines length design of the selected signal transmission line satisfies the design standards. Otherwise, if any actual length is less than the minimum reference length, the device and method determines the length design of the signal transmission line does not satisfy the design standards.

### BACKGROUND

1. Technical Field

Embodiments of the present disclosure relates to circuit simulating systems and methods, and particularly, to a computing device and a method for checking signal transmission lines of a printed circuit board (PCB).

2. Description of Related Art

PCB production processes may include designing a PCB layout, and manufacturing a printed wiring board (i.e., a bare board) according to the PCB layout. A PCB is often arranged with thousands of signal transmission lines. During the design process of the PCB, a signal transmission line may be divided into multiple line segments if corners are designed on the signal transmission line. Due to limitations of etching technology, if a length of a line segment is designed to be too short, a machined width of the line segment may be less than a designed width. If such a situation exists in a manufactured PCB, a copper wire in the PCB, which corresponds to the signal transmission line in the PCB layout file, would burn out when current passes through the thin line segment. Therefore, it is necessary to incorporate design simulations and checks during the design and layout process of the PCB. With the large number of signal transmission lines distributed on the PCB, manual operation is not only time-consuming, but also error-prone.

### BRIEF DESCRIPTION OF THE DRAWINGS

FIG. 1 is a block diagram of one embodiment of a computing device for checking signal transmission lines of a PCB layout file.

FIG. 2 is a block diagram of one embodiment of function modules of a check unit in the computing device of FIG. 1.

FIG. 3 is a flowchart of one embodiment of a method for checking signal transmission lines of a PCB layout file.

FIG. 4 is one embodiment of two signal transmission lines.

### DETAILED DESCRIPTION

The disclosure, including the accompanying drawings in which like references indicate similar elements, is illustrated by way of examples and not by way of limitation. It should be noted that references to “an” or “one” embodiment in this disclosure are not necessarily to the same embodiment, and such references mean at least one.

In general, the word “module,” as used hereinafter, refers to logic embodied in hardware or firmware, or to a collection of software instructions, written in a programming language, such as, for example, Java, C, or Assembly. One or more software instructions in the modules may be embedded in firmware. It will be appreciated that modules may comprised connected logic units, such as gates and flip-flops, and may comprise programmable units, such as programmable gate arrays or processors. The modules described herein may be implemented as either software and/or hardware modules and may be stored in any type of computer-readable medium or other computer storage device.

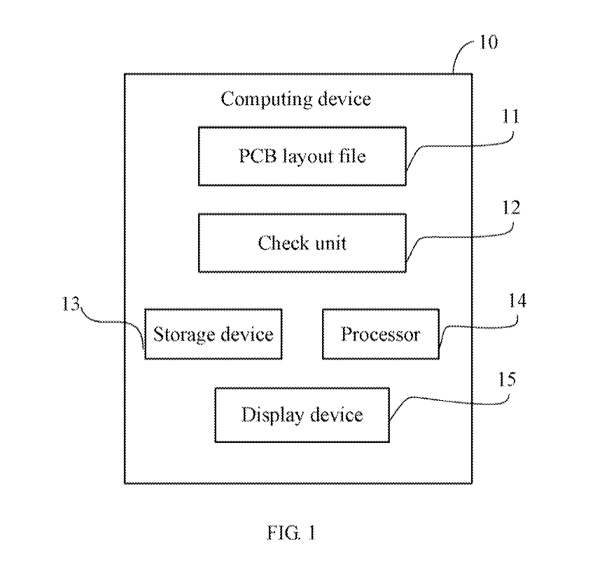

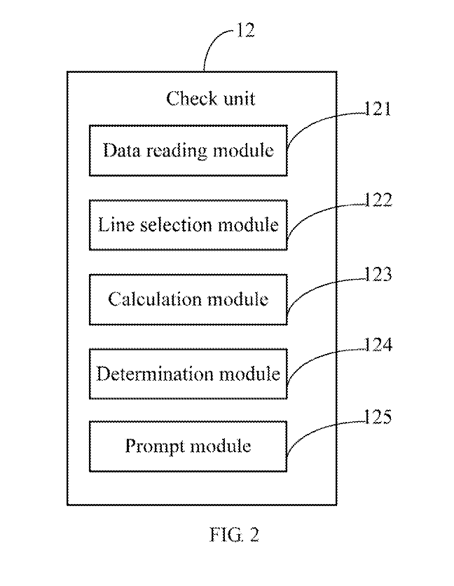

FIG. 1 is a block diagram of one embodiment of a computing device 10. The computing device 10 includes a printed circuit board (PCB) layout file 11, a check unit 12, a storage device 13, a processor 14. The computing device 10 may further include a display device 15, or connect to the display device 15. The check unit 12 includes a number of function modules (as shown in FIG. 2). The function modules may comprise computerized code in the form of one or more programs that are stored in the storage device 13. The computerized code includes instructions that are executed by the processor 14, to check information of the signal transmission lines, such as a length of each line segment of a signal transmission line in the PCB layout file 11. The PCB layout file 11 can comprise one or more files detailing layout information of signal transmission lines and related components of one or more printed circuit boards.

The storage device 13 further stores design standards of the signal transmission lines in the PCB layout file 11, such as a reference length of each line segment of a signal transmission line, and a reference distance between two neighboring signal transmission lines. The display device 15 displays the PCB layout file 11 and a user interface allowing selection of signal transmission lines to be checked and outputs check results. Depending on the embodiment, the storage device 13 may be a smart media card, a secure digital card, or a compact flash card. The computing device 10 may be a personal computer, or a server, for example.

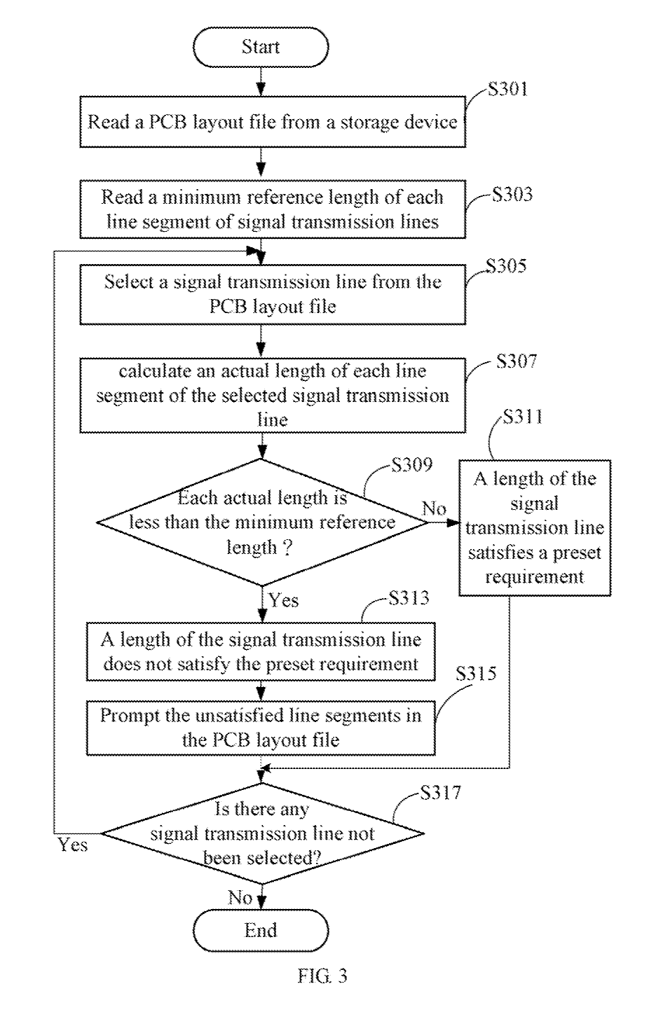

FIG. 2 is a block diagram of the function modules of the check unit 12 in the computing device 10 of FIG. 1. In one embodiment, the check unit 12 includes a data reading module 121, a line selection module 122, a calculation module 123, a determination module 124, and a prompt module 125. A detailed description of the modules 121-125 is illustrated in FIG. 3.

FIG. 3 is a flowchart of one embodiment of a method for checking signal transmission lines of the PCB layout file 11. Depending on the embodiment, additional steps may be added, others removed, and the ordering of the steps may be changed.

In step S301, the data reading module 121 reads the PCB layout file 11 from the storage device 13. As mentioned above, the PCB layout file 11 includes arrangement information of the signal transmission lines of a PCB, such as the number of the signal transmission lines arranged on the PCB, a length of each signal transmission line, and an orientation of each signal transmission line.

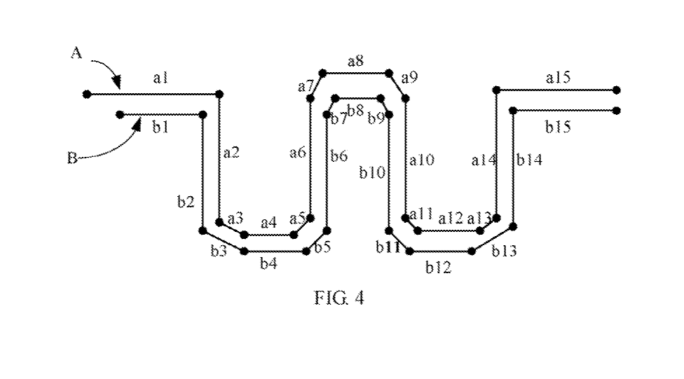

In step S303, the data reading module 11 reads design standards of the signal transmission lines from the storage device 13, and determines a minimum value (such as 4 mil) of reference lengths (hereinafter “the minimum reference length”) of line segments of the signal transmission lines. As mentioned above, the design standards include a reference length of each line segment of each signal transmission line, and a reference distance between two neighboring signal transmission lines. For example, as shown in FIG. 4, a data line A has fifteen line segments labeled from a1-a15, each of the line segments has a reference length, such as 25 mil, 23 mil, 6 mil, 7 mil, 5 mil, 22 mil, 6 mil, 10 mil, 6 mil, 21 mil, 5 mil, 9 mil, 5 mil, 22 mil, and 27 mil, then a minimum value of the reference lengths of the line segments of the data line A is 5 mil. Similarly, the minimum value of the reference lengths of the line segments of all of the signal transmission lines can be determined.

In step S305, the line selection module 122 receives a signal transmission line selected by a user from the PCB layout file 11. In one embodiment, the user can select one signal transmission line at one time. For example, in one embodiment, the data line A shown in FIG. 4 is selected. In other embodiment, the user may select more than one signal transmission lines having the same design standards at one time.

In step S307, the calculation module 123 calculates an actual length of each line segment of the selected signal transmission line. For example, actual lengths of the fifteen line segments of the data line A in FIG. 4 may be 25 mil, 24 mil, 6 mil, 7 mil, 5.5 mil, 22 mil, 6 mil, 10 mil, 7 mil, 22 mil, 3.5 mil, 9 mil, 5 mil, 22 mil, and 28 mil.

In step S309, the determination module 124 checks if an actual length of any line segments of the selected signal transmission line is less than the minimum reference length. If any actual length is more than or equal to the minimum reference length, step S311 is implemented, the determination module 124 determines that length design of the selected signal transmission line satisfies the design standards. Then, the procedure ends. Otherwise, if an actual length of any line segment of the selected signal transmission line is less than the minimum reference length, for example, the actual length of the line segment all of the data line A is less than 4 mil, then step S313 is implemented.

In step S313, the determination module 124 determines the length design of the selected signal transmission line does not satisfy the design standards.

In step S315, the prompt module 125 prompts the selected signal transmission line and the line segment that do not satisfy the design standards in the PCB layout file 11. For example, the prompt module 125 may highlight the line segment all on the data line A in the PCB layout file 11.

In step S317, the determination module 124 checks if there is any signal transmission line that has not been selected in the PCB layout file 11. If there is any signal transmission line that has not been selected in the PCB layout file 11, the procedure returns to step S305. Otherwise, if all signal transmission lines in the PCB layout file 11 have been selected, the procedure ends.

Although certain inventive embodiments of the present disclosure have been specifically described, the present disclosure is not to be construed as being limited thereto. Various changes or modifications may be made to the present disclosure without departing from the scope and spirit of the present disclosure.

What is claimed is:

1. A method being executed by a processor of a computing device for checking signal transmission lines in a printed circuit board (PCB) layout file, the method comprising:
reading the PCB layout file from a storage device, wherein the PCB layout file comprises arrangement information of signal transmission lines of a PCB;
reading design standards of the signal transmission lines from the storage device, and determining a minimum reference length of line segments of the signal transmission lines from the design standards;
calculating an actual length of each line segment of a selected signal transmission line; and
determining length design of the selected signal transmission line satisfies the design standards, if each actual length of the line segments of the selected signal transmission line is more than or equal to the minimum reference length, or determining the length design of the selected signal transmission line does not satisfy the design standards, if any actual length is less than the minimum reference length.

2. The method as claimed in claim 1, further comprising:
prompting the selected signal transmission line and the line segment that do not satisfy the design standards in the PCB layout file.

3. The method as claimed in claim 1, wherein the arrangement information of the signal transmission lines further comprises a number of the signal transmission lines arranged on the PCB, a length of each signal transmission line, and an orientation of each signal transmission line.

4. The method as claimed in claim 3, further comprising:
checking if there is any signal transmission line that has not been selected in the PCB layout file; and
repeating from the calculating step until all of the signal transmission lines have been selected.

5. A computing device, comprising:
a storage device;
at least one processor; and
one or more programs stored in the storage device and executable by the at least one processor, the one or more programs comprising instructions to:
read a printed circuit board (PCB) layout file from a storage device, wherein the PCB layout file comprises arrangement information of signal transmission lines of a PCB;
read design standards of the signal transmission lines from the storage device, and determine a minimum reference length of line segments of the signal transmission lines from the design standards;
calculate an actual length of each line segment of a selected signal transmission line; and
determine length design of the selected signal transmission line satisfies the design standards, if each actual length of the line segments of the selected signal transmission line is more than or equal to the minimum reference length, or determine the length design of the selected signal transmission line does not satisfy the design standards, if any actual length is less than the minimum reference length.

6. The computing device as claimed in claim 5, wherein the one or more programs further comprise instructions to:
prompt the selected signal transmission line and the line segment that do not satisfy the design standards in the PCB layout file.

7. The computing device as claimed in claim 5, wherein the arrangement information of the signal transmission lines further comprises a number of the signal transmission lines arranged on the PCB, a length of each signal transmission line, and an orientation of each signal transmission line.

8. The computing device as claimed in claim 7, wherein the one or more programs further comprise instructions to:
check if there is any signal transmission line that has not been selected in the PCB layout file; and
repeat from the calculate step until all of the signal transmission lines have been selected.

9. A non-transitory computer readable medium storing a set of instructions, the set of instructions capable of being executed by a processor of a computing device to perform a method for checking signal transmission lines in a printed circuit board (PCB) layout file, the method comprising:
reading the PCB layout file from a storage device, wherein the PCB layout file comprises arrangement information of signal transmission lines of a PCB;
reading design standards of the signal transmission lines from the storage device, and determining a minimum reference length of line segments of the signal transmission lines from the design standards;
calculating an actual length of each line segment of a selected signal transmission line; and
determining length design of the selected signal transmission line satisfies the design standards, if each actual length of the line segments of the selected signal transmission line is more than or equal to the minimum reference length, or determining the length design of the selected signal transmission line does not satisfy the design standards, if any actual length is less than the minimum reference length.

10. The medium as claimed in claim 9, wherein the method further comprises:
prompting the selected signal transmission line and the line segment that do not satisfy the design standards in the PCB layout file.

11. The medium as claimed in claim 9, wherein the arrangement information of the signal transmission lines further comprises a number of the signal transmission lines arranged on the PCB, a length of each signal transmission line, and an orientation of each signal transmission line.

12. The medium as claimed in claim 11, wherein the method further comprises:
checking if there is any signal transmission line that has not been selected in the PCB layout file; and
repeating from the calculating step until all of the signal transmission lines have been selected.
